(19) United States
(12) Patent Application Publication
(10) Pub. No.: US 2007/0199065 A1
(43) Pub. Date: Aug. 23, 2007

(54) INFORMATION PROCESSING SYSTEM

(76) Inventors: Yukio Ogawa, Tokyo (JP); Tomohisa Kohiyama, Yokohama (JP); Toshikazu Yasue, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/622,036

(22) Filed: Jan. 11, 2007

(30) Foreign Application Priority Data
Feb. 23, 2006 (JP) 2006-047316

(51) Int. Cl. G06F 15/16; H04L 9/00; G06F 17/00; G06F 9/00

(52) U.S. Cl. 726/15; 713/153; 713/169

(57) ABSTRACT

An information processing system is provided, which allows an information processing device to use network devices across firewall devices without having the firewall devices configured for respective protocols which are to be used for communication with the network devices. By connecting a local machine and a remote machine with each other via a VPN and providing the remote machine with a VPN gateway function, the local machine is allowed to belong to a network on the remote machine side. As a result, in a case where the firewall devices exist between the local machine and the remote machine, merely by setting the firewall devices to connect the local machine and the remote machine with each other via the VPN, the local machine can communicate with the various network devices connected to the network on the remote machine side by means of various protocols.

### BACKGROUND OF THE INVENTION

The present invention relates to a network connection technology for an information processing system, and more particularly, to a technology which connects a local machine to a network device on a remote machine side in an information processing system of a thin client type.

In recent years, a so-called thin client type of information processing system has been gaining attention. An information processing system of the thin client type allows a user to use a nearby remote machine to utilize various application programs and data on a local machine in a workplace or at home through remote-control of a desktop of the local machine. As the local machine, a blade PC (i.e., blade computer) which does not have locally connected input/output devices (such as a keyboard, a mouse, and a display), for example, is used as well as a desktop personal computer (PC) (for example, refer to Japanese Patent Laid-open Publication No. 2003-337672).

In the information processing system of the thin client type described above, in order to use network devices (such as a printer, a scanner, and a file server) connected to a network on the remote machine side, it is necessary to configure a firewall device between the local machine and the network devices so that the local machine and the network devices can communicate with each other. For example, if the network device is a printer, and the local machine transmits a print command to the printer by using a line printer daemon protocol (LPR), it is necessary to set an address and a port so that an LPR packet can be delivered to the printer from the local machine. Further, if the network device is a file server, and the local machine accesses the file server by using file transfer protocol (FTP), it is necessary to set an address and a port so that an FTP packet can be delivered to the printer from the local machine.

As described above, conventionally, it is necessary to configure the firewall devices between the local machine and the network devices for respective protocols to be used for communication with the network devices, which leads to an increase in workload.

### SUMMARY OF THE INVENTION

It is therefore an object of the present application to provide a system which allows an information processing device to use network devices across firewall devices without having the firewall devices configured for the respective protocols which are to be used for the communication with the network devices.

In order to achieve the above-mentioned object, according to the present application, a first information processing device and a second information processing device are connected via a virtual private network (VPN), and the second information processing device is provided with a VPN gateway function, to thereby cause the first information processing device to belong to a network of the second information processing device.

For example, in an information processing system including a first information processing device and a second information processing device, the first information processing device includes a VPN interface unit which connects to a virtual private network (VPN), the second information processing device includes a VPN gateway unit which connects to the VPN and a network other than the VPN, and the VPN gateway unit, when a destination of a packet received via the VPN or the network is an address of the network assigned to the first information processing device, forwards the packet to the VPN, and, when the destination of the packet is a network address other than the address of the network assigned to the first information processing device, forwards the packet to the network.

Herein, the second information processing device may be an operation terminal which functions as an input/output device for the first information processing device.

Further, the second information processing device may further include VPN connection request transmission unit that transmits a VPN connection request to the first information processing device, the first information processing device may further include VPN connection request reception unit that receives the VPN connection request from the second information processing device, and the VPN interface unit, upon the VPN connection request reception unit receiving the VPN connection request, may be connected to the VPN gateway unit via the VPN.

In this way, when firewall device is disposed between the first information processing device and the second information processing device, it is only necessary to set the firewall device such that the first information processing device and the second information processing device can be connected via a VPN to allow the first information processing device to communicate with various network devices belonging to the network on the second information processing device side, via various protocols.

### BRIEF DESCRIPTION OF THE DRAWINGS

In the accompanying drawings:

FIG. 1 shows an example of a schematic configuration of a remote desktop system (information processing system of thin client type) according to a first embodiment;

FIG. 2 shows an example of a schematic configuration of a local machine;

FIG. 3 describes an example of an operation of the local machine;

FIG. 4 shows an example of a schematic configuration of a remote machine;

FIG. 5 describes an example of an operation of the remote machine;

FIG. 6 shows an example of a schematic operation of a remote desktop system according to the first embodiment;

FIG. 7 describes an example of an operation of the local machine;

FIG. 8 describes an example of an operation of the remote machine;

FIG. 9 shows an example of a schematic operation of a remote desktop system according to a second embodiment; and

FIG. 10 shows an example of a schematic configuration of a virtual office system according a third embodiment.

### DESCRIPTION OF THE PREFERRED EMBODIMENTS

### First Embodiment

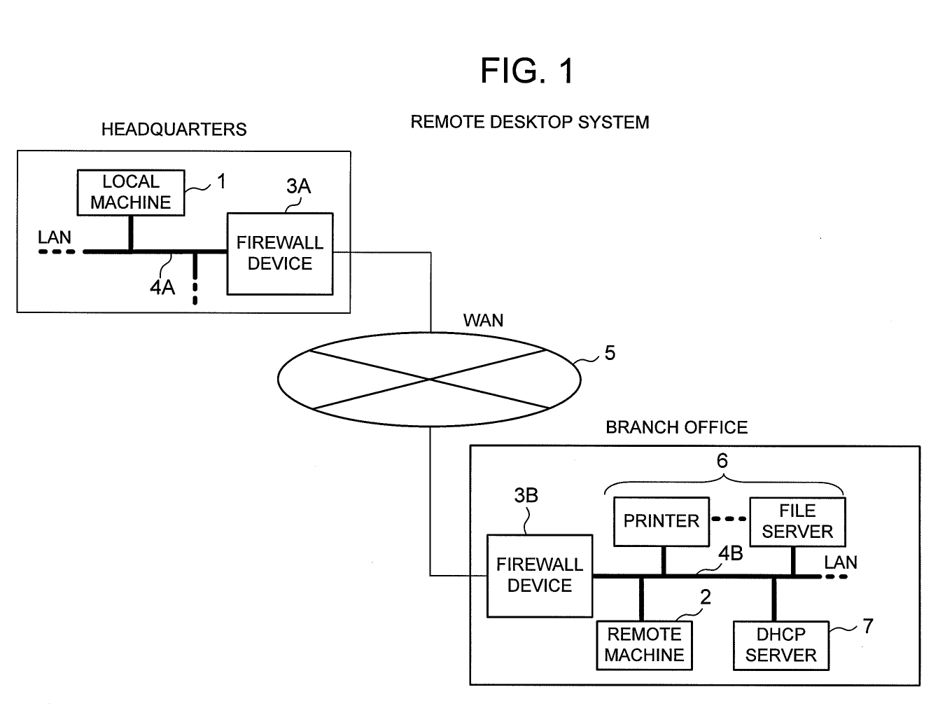

FIG. 1 shows an example of a schematic configuration of a remote desktop system (information processing system of thin client type) according to a first embodiment.

As described in FIG. 1, the remote desktop system according to this embodiment includes a local machine 1, a remote machine 2, network devices 6 such as a printer (printer server), a scanner (scanner server) and a file server, and a dynamic host configuration protocol (DHCP) server 7. The local machine 1 is connected to a local area network (LAN) 4A constructed in the headquarters of a company, for example. The LAN 4A is connected to a wide area network (WAN) 5 via a firewall device 3A. Further, the remote machine 2, the network devices 6, and the DHCP server 7 are connected to a LAN 4B constructed in a branch office of a company, for example. The LAN 4B is connected to the WAN 5 via a firewall device 3B.

The local machine 1 provides the remote machine 2 with a terminal service. That is, the local machine 1 receives and processes input information (operations carried out on input devices) transmitted from the remote machine 2, and transmits image information (desktop screen for a display device) indicating a result of the processing to the remote machine 2. Further, the local machine 1 includes a virtual private network (VPN) interface function for making a connection to the remote machine 2 via a VPN. Then, the local machine 1 uses a VPN gateway function of the remote machine 2, which is described later, to connect to the LAN 4B on the remote machine 2 side. As this local machine 1, a desktop personal computer (PC) or a blade PC (i.e., blade computer) without locally connected input/output devices (such as keyboard, mouse, and display) is used.

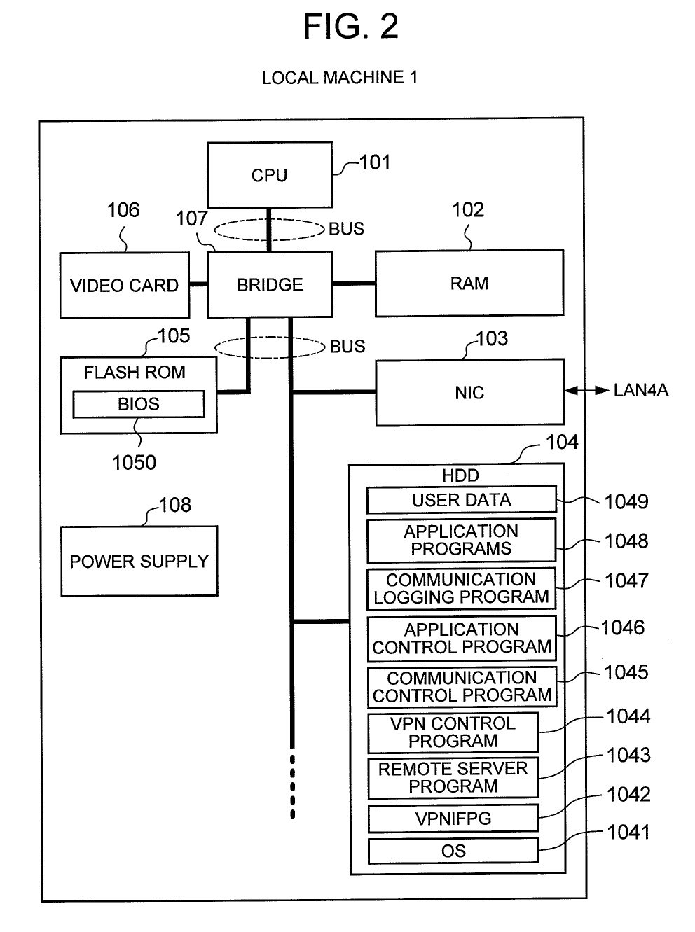

FIG. 2 shows an example of a schematic configuration of the local machine 1.

As shown in FIG. 2, the local machine 1 includes a central processing unit (CPU) 101, a random access memory (RAM) 102 which serves as a work area of the CPU 101, a network interface card (NIC) 103 for connecting to the LAN 4A, a hard disk drive (HDD) 104, a flash read only memory (ROM) 105, a video card 106 which generates image information of the desktop, a bridge 107 which relays internal connection lines such as BUS that connect these respective units 101 to 106 with each other, and a power supply 108.

The flash ROM 105 stores a basic input/output system (BIOS) 1050. After the power supply 108 is turned on, the CPU 101 first accesses the flash ROM 105 and executes the BIOS 1050 to recognize a system configuration of the local machine 1.

The HDD 104 stores at least an operating system (OS) 1041, a VPN interface program 1042, a remote server program 1043, a VPN control program 1044, a communication control program 1045, an application control program 1046, a communication logging program 1047, multiple application programs 1048, and user data 1049.

The OS 1041 is a program for the CPU 101 to comprehensively control the respective units 102 to 108 of the local machine 1, and to execute the respective programs 1042 to 1048 described later. The CPU 101, according to the BIOS 1050, loads the OS 1041 from the HDD 104 to the RAM 102, and executes the OS 1041. As a result, the CPU 101 comprehensively controls the respective units 102 to 108 of the local machine 1.

The VPN interface program 1042 is a program for constructing a VPN to the remote machine 2, and is a communication program using security architecture for the Internet protocol (IPsec), for example. The CPU 101, according to the OS 1041, loads the VPN interface program 1042 from the HDD 104 to the RAM 102, and executes the VPN interface program 1042. As a result, the CPU 101 makes a connection to the remote machine 2 via the VPN.

The remote server program 1043 is a program to provide the terminal service, that is, to enable the remote machine 2 to remotely operate the desktop of the local machine 1, and is a server program for virtual network computing (VNC) developed by AT&T Laboratories Cambridge, for example. The CPU 101, according to the OS 1041, loads the remote server program 1043 from the HDD 104 to the RAM 102, and executes the remote server program 1043. As a result, the CPU 101 receives and processes input information (operations carried out with the keyboard and the mouse) transmitted from the remote machine 2, and transmits image information (desktop screen for the display device) indicating a result of the processing to the remote machine 2.

The VPN control program 1044 is a program for controlling connections over the VPN by means of the VPN interface program 1042. The CPU 101, according to the OS 1041, loads the VPN control program 1044 from the HDD 104 to the RAM 102, and executes the VPN control program 1044. As a result, the CPU 101, according to a VPN connection request received from the remote machine 2 via the NIC 103, causes the VPN interface program 1042 to construct a VPN to the remote machine 2 under predetermined requirements. Here, the predetermined requirements include requirements that the present time is within a predetermined tome period, and/or that an IP address of the remote machine 2 is a predetermined address, and/or that a user of the remote machine 2 is a user to which the VPN communication is permitted.

The communication control program 1045 is a program for controlling communication packets received/transmitted via the VPN, and is a firewall program for carrying out packet filtering, for example. The CPU 101, according to the OS 1041, loads the communication control program 1045 from the HDD 104 to the RAM 102, and executes the communication control program 1045. As a result, the CPU 101 carries out filtering such that a packet which has a predetermined destination, a predetermined transmission source, or a predetermined communication protocol is transmitted/received over the VPN.

The application control program 1046 is a program for controlling the application programs 1048 for communicating with the other party over the VPN, and is a program for permitting activation of an application program which is permitted to transmit/receive data over the VPN, for example. The CPU 101, according to the OS 1041, loads the application control program 1046 from the HDD 104 to the RAM 102, and executes the application control program 1046. As a result, the CPU 101 carries out control such that a predetermined application program 1048 can use the VPN.

The communication logging program 1047 is a program for logging a history of communication with the other party of the application programs 1048 which communicate by means of the VPN. The CPU 101, according to the OS 1041, loads the communication logging program 1047 from the HDD 104 to the RAM 102, and executes the communication logging program 1047. As a result, the CPU 101 stores the history of communication with the other party of the application programs 1048, which communicate by means of the VPN, in the user data 1049.

The application programs 1048 include a general-purpose Web browser, a word processor, a CAD program, and a spreadsheet program. The CPU 101, according to the OS 1041, in response to an instruction received from the remote machine 2 via the remote server program 1043, loads a desired application program 1048 from the HDD 104 to the RAM 102, and executes the application program 1048. Then, the CPU 101 causes the video card 106 to generate image information of a desktop screen reflecting a result of this execution, and transmits the generated image information to the remote machine 2 via the remote server program 1043.

The user data 1049 is data available for use in the application programs 1048, and is data personally used by users (such as document data personally produced or history data produced by the communication logging program 1047).

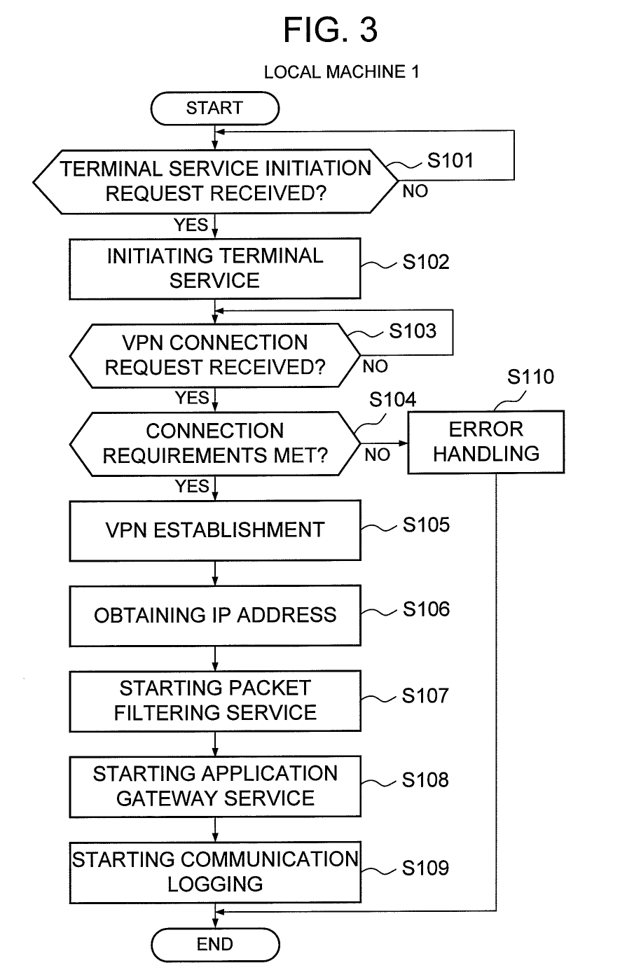

FIG. 3 is a flowchart showing an example of an operation of the local machine 1.

It should be noted that this flowchart is actually executed by the CPU 101 according to a program. However, for the sake of simplicity, a description will be given of the flowchart assuming the program as the main executing entity.

The OS 1041, upon receiving a terminal service initiation request from the remote machine 2 via the NIC 103 (“YES” in a step S101), transmits a terminal service request response to the remote machine 2. The OS 1041 then activates the remote server program 1043 to initiate the terminal service for the remote machine 2 (S102). Specifically, the remote server program 1043, upon receiving input information from the remote machine 2 via the NIC 103, notifies a predetermined activated application program 1048 of the input information. Accordingly, the application program 1048 executes a process in response to operations (keyboard operation and mouse operation) indicated by this input information. The application program 1048 then causes the RAM 102 to produce image information representing a desktop screen reflecting a result of the process (such as color information, draw command information, and bitmap information for drawing on a desktop screen). The remote server program 1043 transmits this image information to the remote machine 2 via the NIC 103.

Next, the OS 1041, upon receiving a VPN connection request from the remote machine 2 via the NIC 103 by means of the terminal service (“YES” in a step S103), notifies the VPN control program 1044 of the reception. Accordingly, the VPN control program 1044 determines whether the predetermined requirements are met (S104). According to this embodiment, the predetermined requirements are that the present time acquired from an internal timer (not shown) is within a predetermined time period (such as business hours on a business day), that a transmission source address of the VPN connection request belongs to a predetermined network (such as a LAN constructed in a predetermined branch office), and that a user of the remote machine 2 is permitted to use the VPN communication, and the VPN control program 1044 determines whether these requirements are met.

If the predetermined requirements are not met in the step S104 (“NO” in the step S104), the VPN control program 1044 carries out predetermined error handling such as transmission of an error message to the transmission source of the VPN connection request via the OS 1041 and the NIC 103 (S110).

On the other hand, if the predetermined requirements are met in the step S104 (“YES” in the step S104), the VPN control program 1044 transmits a VPN connection response to the transmission source of the VPN connection request via the OS 1041 and the NIC 103. The VPN control program 1044 then activates the VPN interface program 1042, and causes the VPN interface program 1042 to establish a VPN to the remote machine 2 which is the source of the VPN connection request (S105).

Once the VPN is established with the remote machine 2, the OS 1041 accesses the DHCP server 7 connected to the LAN 4B on the remote machine 2 side by means of the gateway function of the remote machine 2 described later, and acquires an IP address (local address) from the DHCP server 7 (S106). As a result, the local machine 1 can communicate with the network devices 6 connected to the LAN 4B.

After that, the OS 1041 activates the communication control program 1045 to initiate packet filtering of communication packets transmitted/received via the VPN (S107). For example, the communication control program 1045 filters the packets such that all accesses from the network devices 6 are denied, and an access from the local machine 1 to the network devices 6 is permitted.

Further, the OS 1041 activates the application control program 1046 to initiate an application gateway service (S108). As a result, the application control program 1046 performs control to prohibit application programs 1048 other than predetermined application programs 1048 from using the VPN (VPN interface program 1042), thereby allowing the predetermined application programs 1048 to communicate with the other party by means of the VPN.

Further, the OS 1041 activates the communication logging program 1047. As a result, the communication logging program 1047 records a communication history of the respective application programs 1048 using the VPN in the user data 1049 (S109).

Referring again to FIG. 1, the description will be continued.

The remote machine 2 receives the terminal service from the local machine 1. That is, the remote machine 2 transmits input information input by a user (operations carried out on the input devices) to the local machine 1, and receives image information (color information, draw command information, bitmap information, and the like used for drawing on a desktop screen for the display device) from the local machine 1, and displays the image information on the display device. Further, the remote machine 2 includes the VPN gateway function, and makes a connection to the local machine 1 via a VPN. The remote machine 2 then connects the local machine 1 to the network 4B on the remote machine 2 side. It should be noted that the remote machine 2 is a so-called HDD-less type PC, and is configured so as not to directly (without interposition of the local machine 1) access locally connected peripheral devices and network devices. Namely, the remote machine 2 is configured to use only the devices connected locally and via networks to the local machine 1. This configuration reduces the possibility of information leaks due to theft of the remote machine 2 and the like.

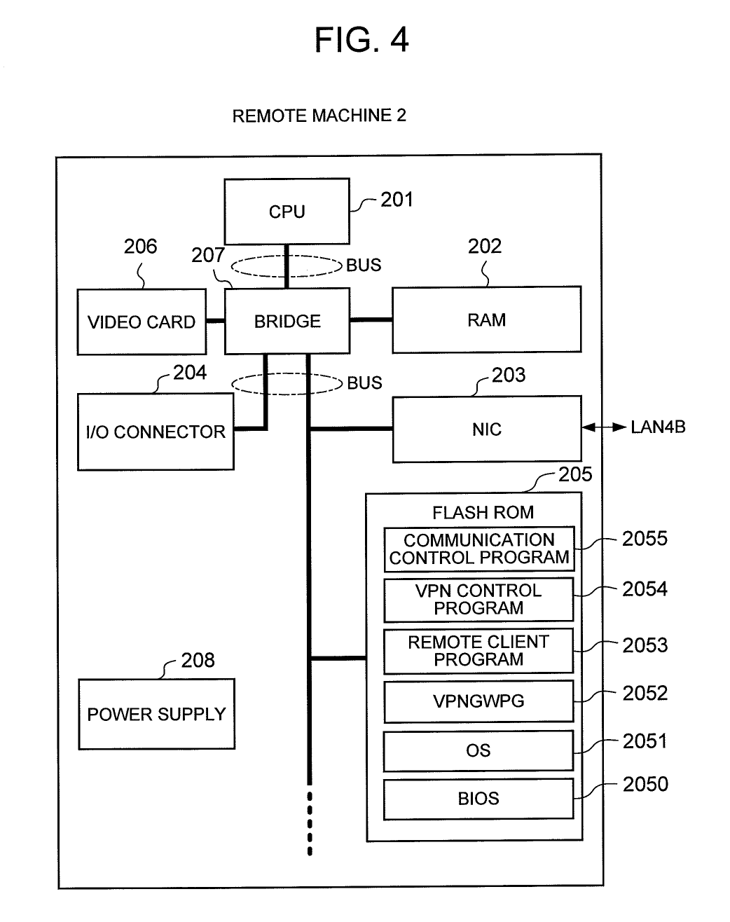

FIG. 4 shows an example of a schematic configuration of a remote machine 2.

As illustrated in FIG. 4, the remote machine 2 includes a CPU 201, a RAM 202 which serves as a work area for the CPU 201, an NIC 203 for connecting to the LAN 4B, an I/O connector 204 for connection with a keyboard and a mouse, a flash ROM 205, a video card 206 for connection of the display device, a bridge 207 which relays internal connection lines such as BUS that connect these respective units 201 to 206 with each other, and a power supply 208.

The flash ROM 205 stores at least a BIOS 2050, an OS 2051, a VPN gateway program 2052, a remote client program 2053, a VPN control program 2054, and a communication control program 2055.

The CPU 201, after the power supply 208 is turned on, first accesses the flash ROM 205 and executes the BIOS 2050 to recognize a system configuration of the remote machine 2.

The OS 2051 is a program for the CPU 201 to comprehensively control the respective units 202 to 208 of the remote machine 2, and to execute the respective programs 2052 to 2055 described later. The CPU 201, according to the BIOS 2050, loads the OS 2051 from the flash ROM 205 to the RAM 202, and executes the OS 2051. As a result, the CPU 201 comprehensively controls the respective units 202 to 208 of the remote machine 2. It should be noted that, as the OS 2051 according to this embodiment, an OS relatively small in size and which can be stored in the flash ROM 205, such as an embedded OS, is used.

The VPN gateway program 2052 is a program for constructing a VPN to the local machine 1, and is a communication program using IPsec or HTTPS, for example. The CPU 201, according to the OS 2051, loads the VPN gateway program 2052 from the flash ROM 205 to the RAM 202, and executes the VPN gateway program 2052. As a result, the CPU 201 constructs a VPN to the local machine 1, and connects the VPN to the LAN 4B.

The remote client program 2053 is a program for using the terminal service, that is, a program for the remote machine 2 to remotely access the desktop of the local machine 1, such as a client (viewer) program of the VNC. The CPU 201, according to the OS 2051, loads the remote client program 2053 from the flash ROM 205 to the RAM 202, and executes the remote client program 2053. As a result, the CPU 201 transmits input information (operations carried out on the keyboard and the mouse) from the I/O connector 204 to the local machine 1, receives image information (such as color information, draw command information, and bitmap information for drawing on a desktop screen for the display device) transmitted from the local machine 1, processes the image information, and displays the processed image information on the display device (not shown) connected to the video card 206.

The VPN control program 2054 is a program for controlling connections over the VPN by means of the VPN gateway program 2052. The CPU 201, according to the OS 2051, loads the VPN control program 2054 from the flash ROM 205 to the RAM 202, and executes the VPN control program 2054. As a result, the CPU 201, according to an instruction for connecting to a VPN received from the input device via the I/O connector 204, transmits a request for connection to the VPN to the local machine 1 via the NIC 203. Further, the CPU 201, according to a VPN connection response received from the local machine 1 via the NIC 203, causes the VPN gateway program 2052 to construct a VPN to the local machine 1 under the predetermined requirements. Here, the predetermined requirements include requirements that the present time is within a predetermined time period, and/or that an IP address of the local machine 2 is a predetermined address, and/or that a user of the remote machine 2 is a user to which the VPN communication is permitted.

The communication control program 2055 is a program for controlling communication packets received/transmitted via the VPN, and is a firewall program for carrying out packet filtering, for example. The CPU 201, according to the OS 2051, loads the communication control program 2055 from the flash ROM 205 to the RAM 202, and executes the communication control program 2055. As a result, the CPU 201 carries out filtering such that a packet which has a predetermined destination, a predetermined transmission source, or a predetermined communication protocol can reciprocate between the VPN and the LAN 4B.

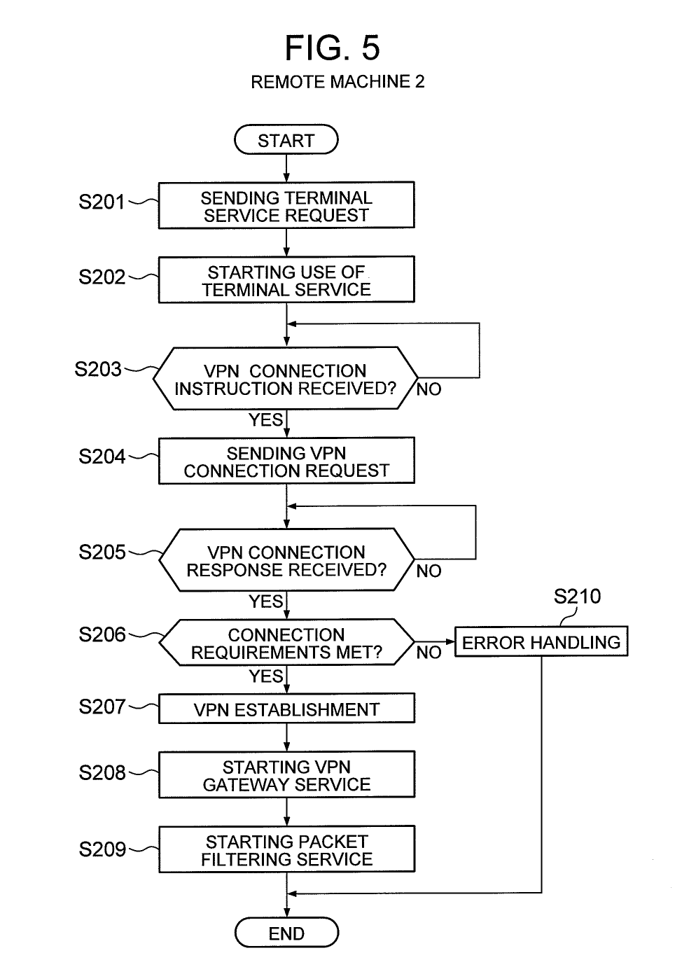

FIG. 5 is a flowchart showing an example of an operation of the remote machine 2.

It should be noted that this flowchart is actually executed by the CPU 201 according to a program. However, for the sake of simplicity, a description will be given of the flowchart assuming the program as the main executing entity.

First, the OS 2051 activates the remote client program 2053. Accordingly, the remote client program 2053 transmits a terminal service request to the local machine 1 via the NIC 203 (S201). The remote client program 2053, upon receiving a terminal service request response from the local machine 1, then initiates the use of the terminal service provided by the local machine 1 (S202). Specifically, the remote client program 2053, upon receiving input information from the input devices via the I/O connector 204, transmits this input information to the local machine 1 via the NIC 203. Further, the remote client program 2053 receives image information for drawing on a desktop screen of the local machine 1 from the local machine 1 via the NIC 203, processes the image information, and displays the processed image information on the display device connected to the video card 206.

Next, the OS 2051, upon receiving a VPN connection instruction from the input devices via the I/O connector 204 (“YES” in a step S203), transmits a VPN connection request to the local machine 1 via the NIC 203 by means of the terminal service (S204). The OS 2051, upon receiving a VPN connection response from the local machine 1 via the NIC 203 (“YES” in a step S205), then notifies the VPN control program 2054 of the reception. Accordingly, the VPN control program 2054 determines whether the predetermined requirements are met (S206). According to this embodiment, the predetermined requirements are that the present time acquired from an internal timer (not shown) or the like is within a predetermined time period (such as business hours on a business day), that a transmission source address of the VPN connection response belongs to a predetermined network (such as the LAN constructed in the headquarters), and that a user of the remote machine 2 is permitted to use the VPN communication. The VPN control program 2054 determines whether these requirements are met.

If the predetermined requirements are not met in the step S206 (“NO” in the step S206), the VPN control program 2054 carries out predetermined error handling such as transmission of an error message to the transmission source of the VPN connection request via the OS 2051 and the NIC 203 (S210).

On the other hand, if the predetermined requirements are met in the step S206 (“YES” in the step S206), the VPN control program 2054 activates the VPN gateway program 2052. Accordingly, the VPN gateway program 2052 establishes a VPN with the local machine 1 which is the source of the VPN connection response (S207).

Further, the VPN gateway program 2052 connects the established VPN to the LAN 4B, and initiates the VPN gateway service (S208).

Specifically, the VPN gateway program 2052 receives a communication packet from the LAN 4B via the NIC 203, and when the communication packet is a VPN packet destined for the remote machine 2 itself, the VPN gateway program 2052 extracts a communication packet stored in this VPN packet and sends out the extracted communication packet to the LAN 4B. When the communication packet is a packet destined for the remote machine 2 itself but not a VPN packet, the VPN gateway program 2052 passes this communication packet to the OS 2051 or the remote client program 2053 via the OS 2051. When the communication packet is a packet destined for an address assigned to the local machine 1 by the DHCP server 7, the VPN gateway program 2052 stores the communication packet in a VPN packet and transmits the VPN packet to the local machine 1. As a result, the local machine 1 can use the network devices 6.

Once the VPN is established with the local machine 1, the OS 2051 activates the communication control program 2055 to initiate the packet filtering of communication packets transmitted/received via the VPN (S209). For example, the communication control program 2055 filters the packets such that all access from the network devices 6 to the local machine 1 is denied, and access from the local machine 1 to the network devices 6 is permitted.

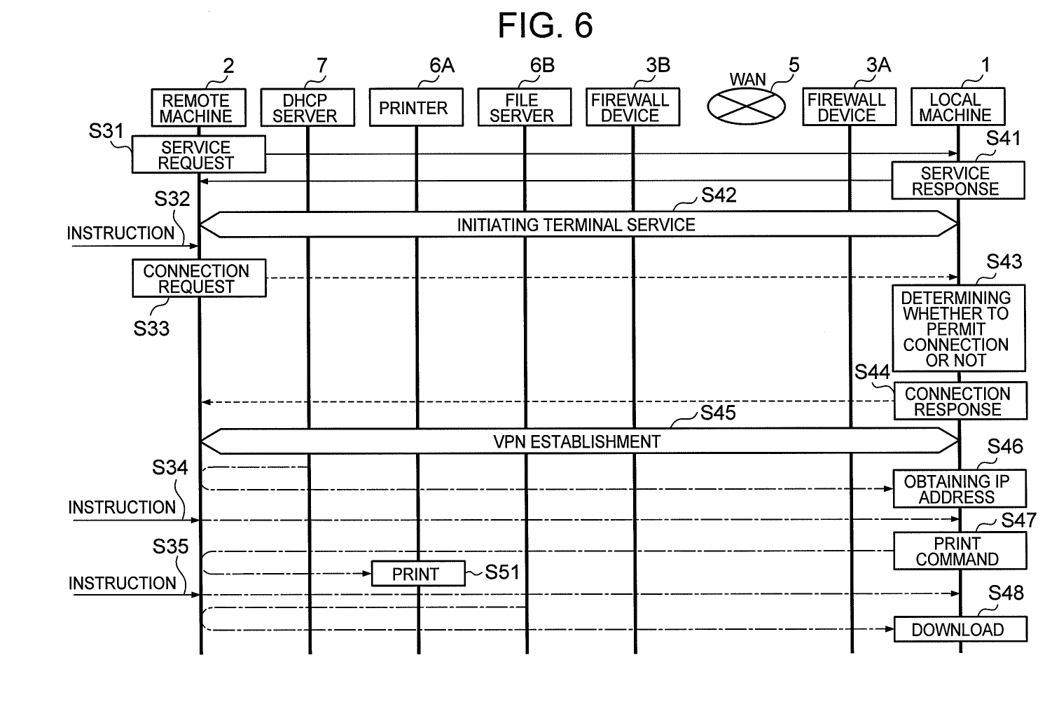

FIG. 6 shows an example of a schematic operation of the remote desktop system according to the first embodiment.

First, the remote machine 2 transmits a terminal service request to the local machine 1 (S31). The local machine 1, upon receiving the terminal service request from the remote machine 2, returns a terminal service response (S41) and initiates provision of the terminal service (S42).

Next, the remote machine 2, upon receiving a request for connecting to the VPN from a user via the input devices (S32), transmits the content of the operation (VPN connection request) to the local machine 1 by means of the terminal service (S33). The local machine 1, upon receiving the VPN connection request from the remote machine 2, determines whether the connection is permitted or not by determining whether predetermined requirements are met (S43). Then, when the connection is permitted, the local machine 1 returns a VPN connection response (S44) and establishes a VPN to the remote machine 2 (S45).

The local machine 1, upon the establishment of the VPN with the remote machine 2, accesses the DHCP server 7 by means of the VPN gateway function of the remote machine 2, and obtains the addresses on the LAN 4B from the DHCP server 7 (S46). Further, the local machine 1 initiates the packet filtering service and the application program control service. On the other hand, the remote machine 2 initiates the packet filtering service.

The remote machine 2, upon receiving a print instruction from a user via the input devices, transmits the content of the operation (print instruction) to the local machine 1 by means of the terminal service (S34). The local machine 1, upon receiving the print instruction from the remote machine 2, produces a print command and transmits the produced print command to the printer 6A by means of the VPN gateway function of the remote machine 2 (S47). The printer 6A, according to the print command received from the local machine 1 via the remote machine 2, prints a requested document (S51).

Further, the remote machine 2, upon receiving a download instruction from a user via the input devices, transmits the content of the operation (download instruction) to the local machine 1 by means of the terminal service (S35). The local machine 1, upon receiving the download instruction from the remote machine 2, accesses the file server 6B by means of the VPN gateway function of the remote machine 2, and downloads a desired file from the file server 6B (S48).

The above description has been given for the first embodiment.

According to this embodiment, by connecting the local machine 1 and the remote machine 2 with each other via the VPN and providing the remote machine 2 with the VPN gateway function, the local machine 1 is made to belong to the network on the remote machine 2 side. As a result, the firewall devices 3A and 3B are between the local machine 1 and the remote machine 2, merely by setting the firewall devices 3A and 3B to connect the local machine 1 and the remote machine 2 with each other via the VPN, the local machine 1 can communicate with the various network devices 6, such as the printer 6A and the file server 6B belonging to the network 4B on the remote machine 2 side, by means of various protocols such as LPR and FTP. That is, it is not necessary to set the firewall devices 3A and 3B for respective protocols.

Further, a user can use the various network devices 6 connected to the LAN 4B to which the remote machine 2 is connected, the same as various devices locally connected, or connected via a network, to the local machine 1.

### Second Embodiment

The above description for the first embodiment is given of the example in which a VPN is not used for the terminal service. A description will be given of an example in which a VPN is used for the terminal service according to this embodiment. It should be noted that the schematic configuration of the remote desktop system and the schematic configuration of the respective devices constituting the remote desktop according to this embodiment are the same as those according to the first embodiment.

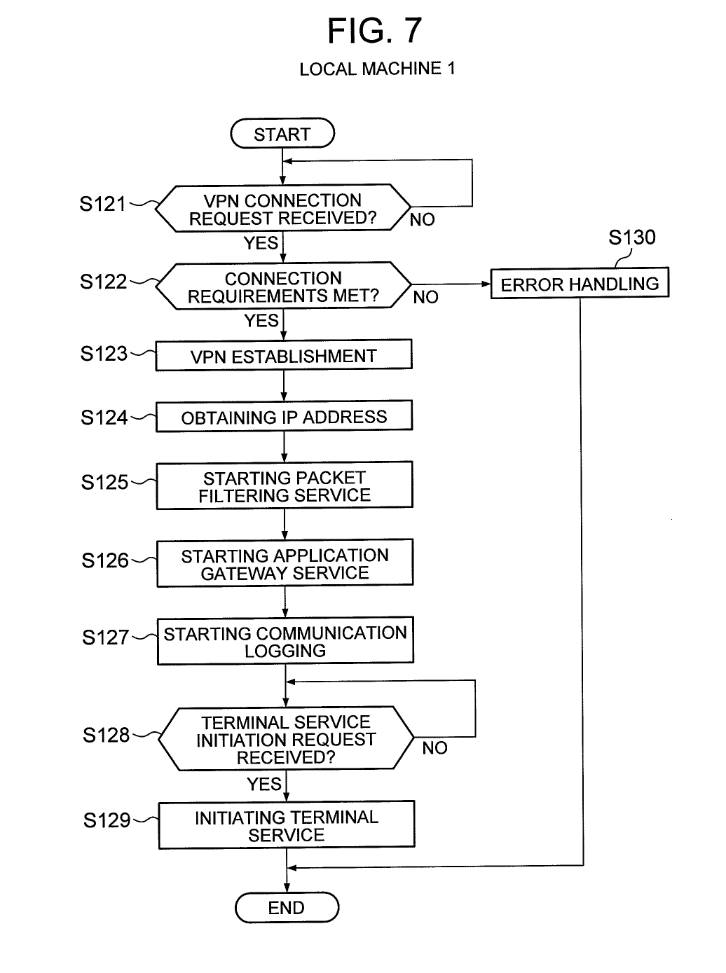

FIG. 7 describes an example of an operation of the local machine 1.

The OS 1041, upon receiving a VPN connection request from the remote machine 2 via the NIC 103 (“YES” in a step S121), notifies the VPN control program 1044 of the reception. Accordingly, the VPN control program 1044 determines whether the predetermined requirements are met as in the first embodiment (S122).

If the predetermined requirements are not met in the step S122 (“NO” in the step S122), the VPN control program 1044 carries out predetermined error handling such as transmission of an error message to the transmission source of the VPN connection request via the OS 1041 and the NIC 103 (S130).

On the other hand, if the predetermined requirements are met in the step S122 (“YES” in the step S122), the VPN control program 1044 transmits a VPN connection response to the transmission source of the VPN connection request via the OS 1041 and the NIC 103. Then, the VPN control program 1044 activates the VPN interface program 1042, and causes the VPN interface program 1042 to establish a VPN to the remote machine 2 which is the source of the VPN connection request (S123).

Once the VPN is established with the remote machine 2, the OS 1041 accesses the DHCP server 7 connected to the LAN 4B on the remote machine 2 side by means of the gateway function of the remote machine 2, and acquires an network address (local address) from the DHCP server 7 (S124). As a result, the local machine 1 can communicate with the network devices 6 connected to the LAN 4B.

After that, the OS 1041 activates the communication control program 1045, and initiates packet filtering of communication packets transmitted/received via the VPN as in the first embodiment (S125). Further, the OS 1041 activates the application control program 1046, and initiates the application program control service (S126). Further, the OS 1041 activates the communication logging program 1047, and initiates recording communication history of the respective application programs 1048 using the VPN (S127).

The OS 1041, upon receiving a terminal service request from the remote machine 2 via the VPN (“YES” in a step S128), then transmits a terminal service request response to the remote machine 2 via the VPN. The OS 1041 then activates the remote server program 1043 to initiate providing the remote machine 2 with the terminal service via the VPN (S129).

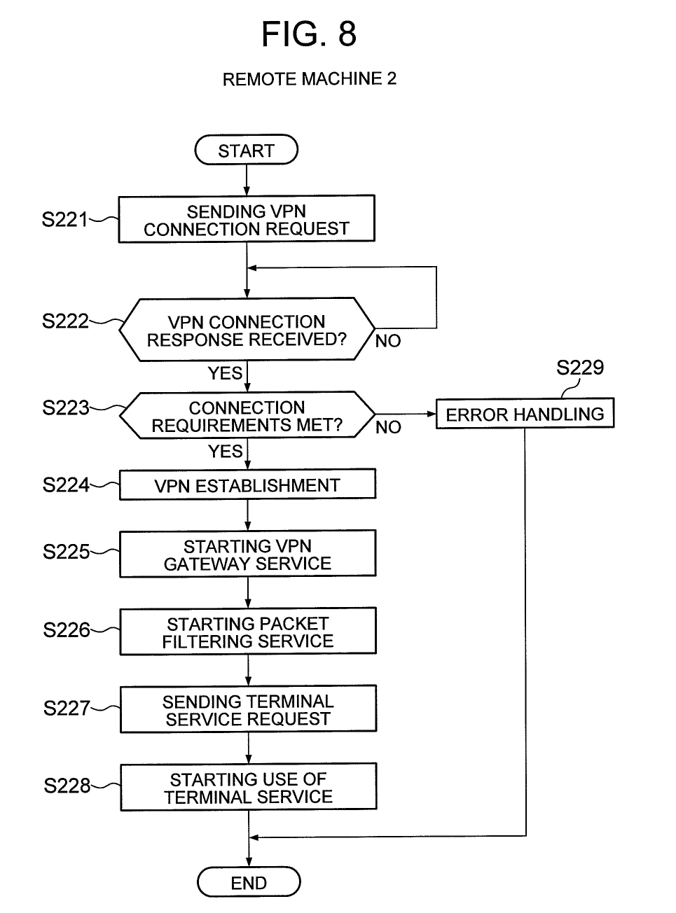

FIG. 8 describes an example of an operation of the remote machine 2.

First, the OS 2051 transmits a VPN connection request to the local machine 1 via the NIC 203 by means of the terminal service (S221). The OS 2051, upon receiving the VPN connection response from the local machine 1 via the NIC 203 (“YES” in a step S222), then notifies the VPN control program 2054 of the reception. Accordingly, the VPN control program 2054 determines whether predetermined requirements are met, as in the first embodiment (S223).

If the predetermined requirements are not met in the step S223 (“NO” in the step S223), the VPN control program 2054 carries out predetermined error handling such as transmission of an error message to the transmission source of the VPN connection response via the OS 2051 and the NIC 203 (S229).

On the other hand, if the predetermined requirements are met in the step S223 (“YES” in the step S223), the VPN control program 2054 activates the VPN gateway program 2052. Accordingly, the VPN gateway program 2052 establishes a VPN to the local machine 1 which is the source of the VPN connection response (S224). Further, the VPN gateway program 2052 connects the established VPN to the LAN 4B, and initiates the VPN gateway service (S225).

Specifically, the VPN gateway program 2052 receives a communication packet from the LAN 4B via the NIC 203. When the communication packet is a VPN packet destined for the remote machine 2 itself, the VPN gateway program 2052 extracts a communication packet stored in this VPN packet, and determines the destination of the extracted communication packet. If the destination is the remote machine 2 itself, the VPN gateway program 2052 passes this contained communication packet to the OS 2051 or the remote client program 2053 via the OS 2051. If the destination is not the remote machine 2 itself, the VPN gateway program 2052 sends out the extracted communication packet to the network 4B. When the communication packet received via the NIC 203 is a packet destined for the remote machine 2 itself other than a VPN packet, the VPN gateway program 2052 passes this communication packet to the OS 2051 or the remote client program 2053 via the OS 2051. When the communication packet received from the LAN 4B via the NIC 203 is a packet destined for an address assigned to the local machine 1 by the DHCP server 7, the VPN gateway program 2052 stores the communication packet in a VPN packet, and transmits the VPN packet to the local machine 1. As a result, the local machine 1 comes to use the network devices 6.

Once the VPN is established to the local machine 1, in a same way as that of the first embodiment, the OS 2051 activates the communication control program 2055 to initiate the packet filtering of communication packets transmitted/received via the VPN (S226).

The OS 2051 then activates the remote client program 2053. Accordingly, the remote client program 2053 transmits a terminal service request to the local machine 1 via the VPN (S227). The remote client program 2053, upon receiving a terminal service request response from the local machine 1 via the VPN, initiates to use the terminal service provided via the VPN by the local machine 1 (S228).

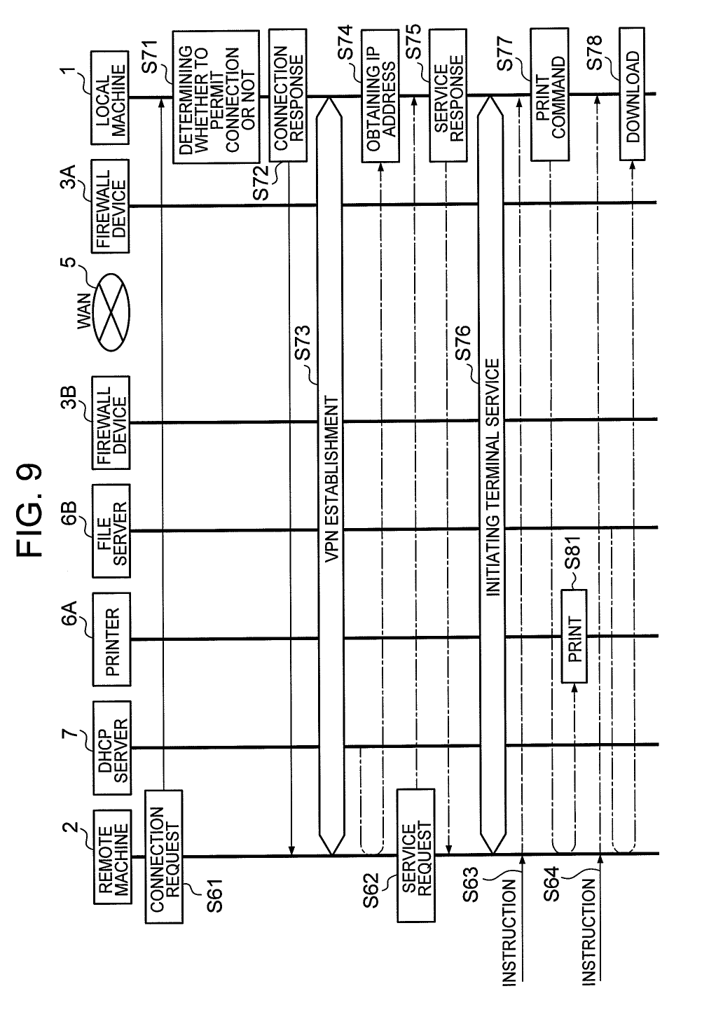

FIG. 9 shows an example of a schematic operation of a remote desktop system according to the second embodiment.

First, the remote machine 2 transmits a VPN connection request to the local machine 1 (S61). The local machine 1, upon receiving the VPN connection request from the remote machine 2, determines whether the connection is permitted or not by determining whether the predetermined requirements are met (S71). If the connection is permitted, the local machine 1 returns a VPN connection response (S72), and establishes a VPN with the remote machine 2 (S73).

The local machine 1, upon the establishment of the VPN with the remote machine 2, accesses the DHCP server 7 by means of the VPN gateway function of the remote machine 2, and obtains the addresses on the LAN 4B from the DHCP server 7 (S74). Further, the local machine 1 initiates the packet filtering service and the application program control service. On the other hand, the remote machine 2 initiates the packet filtering service.

The remote machine 2 then transmits a terminal service request to the local machine 1 via the VPN (S62). The local machine 1, upon receiving the terminal service request from the remote machine 2 via the VPN, returns a terminal service response (S75), and initiates providing the terminal service by means of the VPN (S76).

The remote machine 2, upon receiving a print instruction from a user via the input devices, transmits the content of the operation (print instruction) to the local machine 1 by means of the terminal service on the VPN (S63). The local machine 1, upon receiving the print instruction from the remote machine 2, produces a print command, and transmits the produced print command to the printer 6A by means of the VPN gateway function of the remote machine 2 (S77). The printer 6A, according to the print command received from the local machine 1 via the remote machine 2, prints a requested document (S81).

Further, the remote machine 2, upon receiving a download instruction from a user via the input devices, transmits the content of the operation (download instruction) to the local machine 1 by means of the terminal service on the VPN (S64). The local machine 1, upon receiving the download instruction from the remote machine 2, accesses the file server 6B by means of the VPN gateway function of the remote machine 2, and downloads a desired file from the file server 6B (S78).

The above description has been given for the second embodiment.

This embodiment uses the VPN for the terminal service. As a result, in addition to the effects of the first embodiment, when the firewall devices 3A and 3B are between the local machine 1 and the remote machine 2, the terminal service between the local machine land the remote machine 2 can be realized only by setting the firewall devices 3A and 3B so that the local machine 1 and the remote machine 2 can be connected with each other via the VPN.

### Third Embodiment

A description will now be given of a virtual office system by means of the remote desktop system according to the first and/or second embodiments.

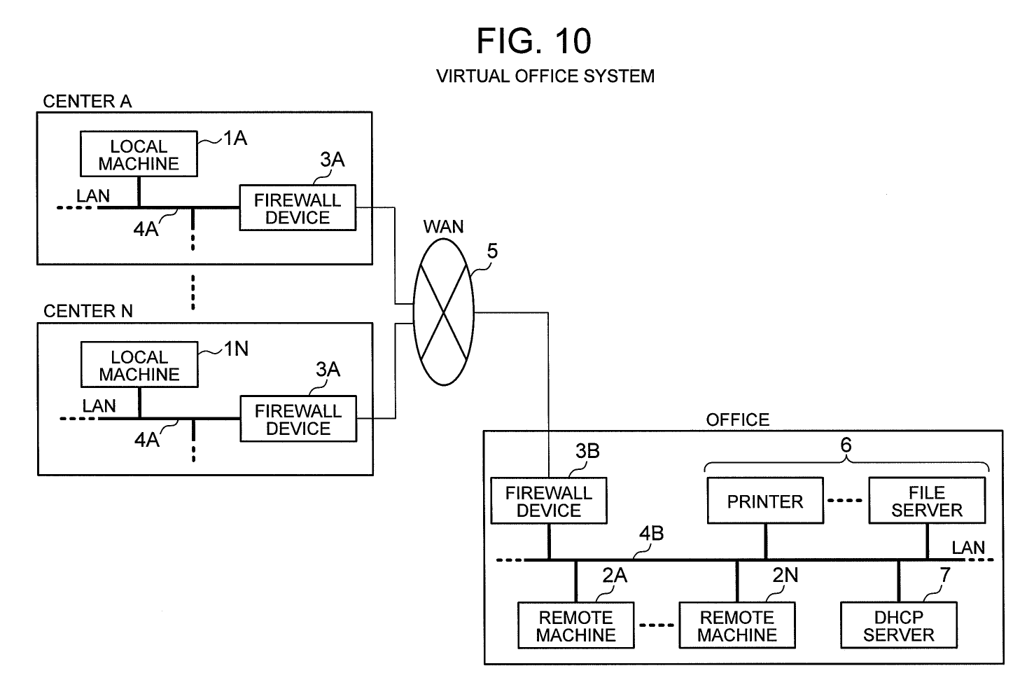

FIG. 10 shows an example of a schematic configuration of a virtual office system according a third embodiment.

As illustrated, the virtual office system according to this embodiment includes multiple local machines 1A to 1N, multiple remote machines 2A to 2N, the network devices 6 such as a printer (printer server), a scanner (scanner server), and a file server, and the DHCP server 7.

The local machines 1A to 1N are respectively connected to the LAN's 4A of different application service providers (ASP), Center A to Center N. The LAN's 4A are connected to the WAN 5 via the firewall devices 3A.

The remote machines 2A to 2N are connected to the LAN 4B constructed within the same office along with the network devices 6 and the DHCP server 7. The LAN 4B is connected to the WAN 5 via a firewall device 3B.

The local machines 1A to 1N respectively provide the remote machines 2A to 2N corresponding to the local machines 1A to 1N with the terminal service. That is, the local machines 1A to 1N respectively receive and process input information (operations carried out on the input devices) transmitted from the corresponding remote machines 2A to 2N, and transmit image information representing a result of the processing (color information, draw command information, bitmap information, and the like, used to draw a desktop image for the display device) to the corresponding remote machines 2A to 2N. Further, the local machines 1A to 1N provide the VPN interface function, and make a connection to the remote machines 2A to 2N respectively corresponding to the local machines 1A to 1N. On the other hand, the remote machines 2A to 2N provide the VPN gateway function, and connect the VPN, configured with the local machines 1A to 1N respectively that correspond to the remote machines 2A to 2N, to the LAN 4B.

As a result, the local machines 1A to 1N use the VPN gateway function of the remote machines 2A to 2N respectively corresponding to the local machines 1A to 1N to connect to the network 4B of the office. The local machines 1A to 1N may be mutually connected with each other via the corresponding remote machines 2A to 2N. The local machine 1 and the remote machine 2, which are used in the remote desktop system according to the first and/or second embodiments, may be used as the local machines 1A to 1N and the remote machines 2A to 2N.

The above description has been given for the third embodiment.

According to this embodiment, since the remote machines 2A to 2N are connected to the LAN 4B of the same office, the local machines 1A to 1N can use the network devices 6 connected to the LAN 4B. Thus, an environment is provided where the local machines 1A to 1N are installed in the same office, and can use the same network devices 6, that is, a virtual office environment.

The present invention is not limited to the above-mentioned respective embodiments, and may be modified in various ways within the scope thereof.

For example, the description of the above-mentioned respective embodiments is given of the example in which the local machine 1 provides the remote machine 2 with the terminal service, but the present application is not limited to this example. The present application may be applied to any configurations as long as a first computer which provides the VPN interface function and a second computer which provides the VPN gateway function are connected with each other via a VPN, and the first computer uses the VPN gateway function of the second computer to make a connection to the same network as of the second computer.

Further, for the above-mentioned respective embodiments, the respective programs maybe installed from a portable recording medium such as a CD-ROM and a DVD-ROM to the computers (local machine 1 and remote machine 2). Alternatively, the respective programs may be downloaded and installed on the computers via a communication medium such as a digital signal, a carrier wave, and a network. Further, the above-mentioned respective embodiments maybe combined with each other.

The present application enables an information processing device to use network devices over firewall devices without configuring the firewall devices for respective protocols used for communication with the network devices.

What is claimed is:

1. An information processing system, comprising:
a first information processing device; and
a second information processing device; wherein:
the first information processing device comprises a VPN interface unit which connects to a virtual private network (VPN);
the second information processing device comprises a VPN gateway unit which connects to the VPN and a network other than the VPN; and
the VPN gateway unit, when a destination of a packet received via one of the VPN and the network is an address of the network assigned to the first information processing device, forwards the packet to the VPN, and when the destination of the packet is a network address other than the address of the network assigned to the first information processing device, forwards the packet to the network.

2. The information processing system according to claim 1, wherein the second information processing device is an operation terminal which functions as an input and output device for the first information processing device.

3. The information processing system according to claim 1, wherein:
the second information processing device further comprises a VPN connection request transmission unit which transmits a request for connection to the VPN to the first information processing device;
the first information processing device further comprises a VPN connection request reception unit which receives the request for connection to the VPN from the second information processing device; and
the VPN interface unit, when the VPN connection request reception unit receives the request for connection to the VPN, makes a connection to the VPN gateway unit via the VPN.

4. The information processing system according to claim 1, wherein the VPN interface unit, when a predetermined requirement is met, makes a connection to the VPN gateway unit via the VPN.

5. The information processing system according to claim 4, wherein the predetermined requirement comprises a requirement that time of the connection to the VPN gateway unit is within a predetermined time period.

6. The information processing system according to claim 4, wherein the predetermined requirement comprises a requirement that the second information processing device belongs to a predetermined network.

7. The information processing system according to claim 4, wherein the predetermined requirement comprises a requirement that a user of the second information processing device is a predetermined user.

8. The information processing system according to claim 1, wherein the first information processing device further comprises a communication control unit which controls a communication packet communicated with the VPN gateway unit by the VPN interface unit.

9. The information processing system according to claim 1, wherein the first information processing device further comprises an application program control unit which controls an application program for receiving and transmitting communication data via the VPN interface unit.

10. The information processing system according to claim 1, wherein the first information processing device uses the VPN interface unit to communicate with a network device connected to the network.

11. The information processing system according to claim 10, wherein the network device comprises a file server.

12. The information processing system according to claim 10, wherein the network device comprises a printer.

13. The information processing system according to claim 10, wherein the first information processing device further comprises a logging unit which records a history of communication between the application program and the network device.

14. A virtual office system, comprising a plurality of information systems according to any one of claims 1 to 13, wherein the second information processing device of each information processing system is connected to the same network via the VPN gateway unit of the second information processing device.

15. A first information processing device according to any one of claims 1 to 13.

16. A second information processing device according to any one of claims 1 to 13.

17. A program, which is executed on a computer, the program controlling the computer to function as a VPN gateway unit which makes a connection to one of a virtual private network (VPN) and a network other than the VPN,
wherein the VPN gateway unit, when a destination of a packet received via one of the VPN and the network is an address of the network assigned to a predetermined network device, forwards the packet to the VPN, and when the destination of the packet is an address other than the address of the network assigned to the predetermined network device, forwards the packet to the network.

18. A program, which is executed on a computer, the program controlling the computer to function as a VPN interface unit which receives a request for connection to a virtual private network (VPN) and as a VPN interface unit which makes a connection to the VPN,
wherein the VPN interface unit, when the VPN connection request reception unit receives a request for connection to the VPN, makes a connection to a source of the request for connection to the VPN via the VPN.

19. A communication method which causes a first information processing device to communicate with a network device connected to a second information processing device via a network, comprising:
making, by the first information processing device, a connection to the second information processing device via a virtual private network (VPN);
forwarding, by the second information processing device, when a destination of a packet, received via one of the VPN and the network, is an address of the network assigned to the first information processing device, the packet to the VPN; and
forwarding, by the second information processing device, when the destination of the packet, received via one of the VPN and the network, is an address other than the address of the network assigned to the first information processing device, the packet to the network.
